(19) United States
(12) Patent Application Publication
(10) Pub. No.: US 2026/0067433 A1
(43) Pub. Date: Mar. 5, 2026

(54) PROJECTION MAPPING CALIBRATION SYSTEM, METHOD, AND NON-TRANSITORY COMPUTER READABLE STORAGE MEDIUM THEREOF

(71) Applicant: HTC Corporation, Taoyuan City (TW)

(72) Inventors: Jia-Yau SHIAU, Taoyuan City (TW); Yi-Chen LIN, Taoyuan City (TW)

(21) Appl. No.: 18/823,673

(22) Filed: Sep. 3, 2024

(51) Int. Cl. H04N 9/31; G06T 7/12; G06T 7/13; G06T 7/80

(52) U.S. Cl. CPC H04N 9/3179; G06T 7/12; G06T 7/13; G06T 7/80; H04N 9/3191

(57) ABSTRACT

A projection mapping calibration system, method, and non-transitory computer readable storage medium thereof are provided. The system captures an image frame corresponding to a projection target object. The system calculates a plurality of feature points corresponding to the projection target object in the image frame. The system projects a light sculpting image onto the projection target object. The system captures a light sculpting image frame corresponding to the light sculpting image. The system calculates a plurality of light sculpting feature points corresponding to the projection target object in the light sculpting image frame. The system generates a projection mapping calibration corresponding to the light sculpting image based on a difference value of each of the feature points and the light sculpting feature points.

### BACKGROUND

### Field of Invention

The present invention relates to a projection mapping calibration system, method, and non-transitory computer readable storage medium thereof. More particularly, the present invention relates to a projection mapping calibration system, method, and non-transitory computer readable storage medium thereof that can correctly perform projection image calibration.

### Description of Related Art

Generally speaking, when operating architectural light sculpting, in order for the projection device to accurately project the projected image onto the building, a projection image alignment operation needs to be performed to align the projected image with multiple edges and corners of the building.

In the prior art, the projection image alignment operation is usually preliminarily calculated by software, and then on-site professionals perform on-site adjustments of the projected image based on the on-site projection conditions.

However, the aforementioned on-site adjustment operation of the projected image requires a large amount of professional labor and increases a lot of costs. In addition, since the on-site projection conditions often change over time, errors may occur in the on-site adjustment operation. Thus, the projection mapping calibration cannot be correctly performed.

Accordingly, there is an urgent need for a projection mapping calibration technology that can correctly perform projection image calibration.

### SUMMARY

An objective of the present disclosure is to provide a projection mapping calibration system. The projection mapping calibration system comprises a projection device, an image capturing device, and a processor. The processor is communicatively connected to the projection device and the image capturing device. The image capturing device is configured to capture an image frame corresponding to a projection target object. The processor calculates a plurality of feature points corresponding to the projection target object in the image frame. The projection device projects a light sculpting image onto the projection target object. The image capturing device captures a light sculpting image frame corresponding to the light sculpting image. The processor calculates a plurality of light sculpting feature points corresponding to the projection target object in the light sculpting image frame. The processor generates a projection mapping calibration corresponding to the light sculpting image based on a difference value of each of the feature points and the light sculpting feature points.

Another objective of the present disclosure is to provide a projection mapping calibration method, which is adapted for use in an electronic system. The electronic system comprises a projection device, an image capturing device, and a processor. The image capturing device is configured to capture an image frame corresponding to a projection target object. The projection mapping calibration method comprises the following steps: calculating a plurality of feature points corresponding to the projection target object in the image frame; projecting a light sculpting image onto the projection target object; capturing a light sculpting image frame corresponding to the light sculpting image; calculating a plurality of light sculpting feature points corresponding to the projection target object in the light sculpting image frame; and generating a projection mapping calibration corresponding to the light sculpting image based on a difference value of each of the feature points and the light sculpting feature points.

A further objective of the present disclosure is to provide a non-transitory computer readable storage medium having a computer program stored therein. The computer program comprises a plurality of codes, the computer program executes a projection mapping calibration method after being loaded into an electronic system. The electronic system comprises a projection device, an image capturing device, and a processor. The image capturing device is configured to capture an image frame corresponding to a projection target object. The projection mapping calibration method comprises the following steps: calculating a plurality of feature points corresponding to the projection target object in the image frame; projecting a light sculpting image onto the projection target object; capturing a light sculpting image frame corresponding to the light sculpting image; calculating a plurality of light sculpting feature points corresponding to the projection target object in the light sculpting image frame; and generating a projection mapping calibration corresponding to the light sculpting image based on a difference value of each of the feature points and the light sculpting feature points.

The projection mapping calibration technology (at least including the system, the method, and the non-transitory computer readable storage medium) provided by the present disclosure sets an image capturing device to capture image frame and the light sculpting image frame corresponding to the projection target object, and generates a projection mapping calibration corresponding to the light sculpting image based on the difference values between the feature points in the image frame and the light sculpting feature points in the light sculpting image frame. The projection mapping calibration technology provided in the present disclosure can automatically perform calibration operations through computer vision technology, and efficiently generates the projection mapping calibration without human intervention. Therefore, the projection mapping calibration technology provided by the present disclosure can quickly generate projection mapping calibration, improve the accuracy of the projection operation performed by the projection device, and reduce the cost of the calibration operation.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic view depicting the projection mapping calibration system of the first embodiment;

FIG. 2 is a schematic view depicting the image capturing device of some embodiment;

FIG. 3 is a schematic view depicting the feature points and the light sculpting feature points of some embodiment;

FIG. 4 is a schematic view depicting the light sculpting image frame including a plurality of segments of some embodiment; and

FIG. 5 is a partial flowchart depicting a projection mapping calibration method of the second embodiment.

### DETAILED DESCRIPTION

In the following description, a projection mapping calibration system, method, and non-transitory computer readable storage medium thereof according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

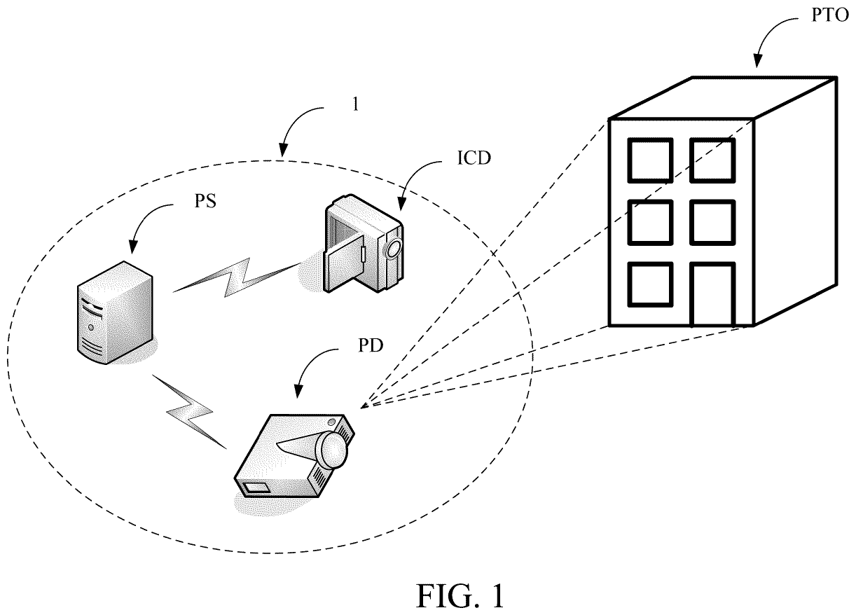

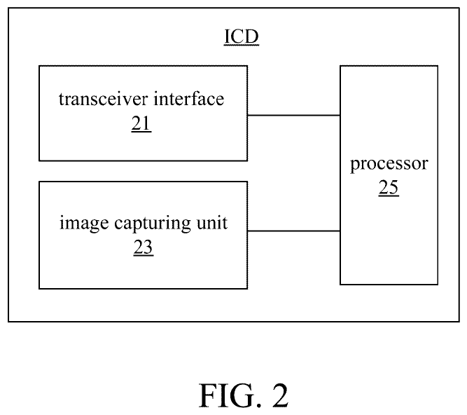

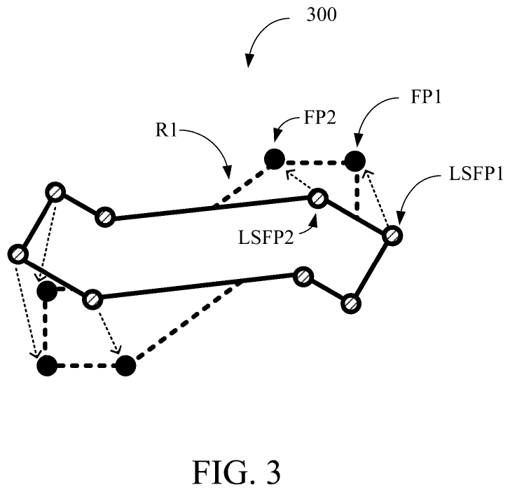

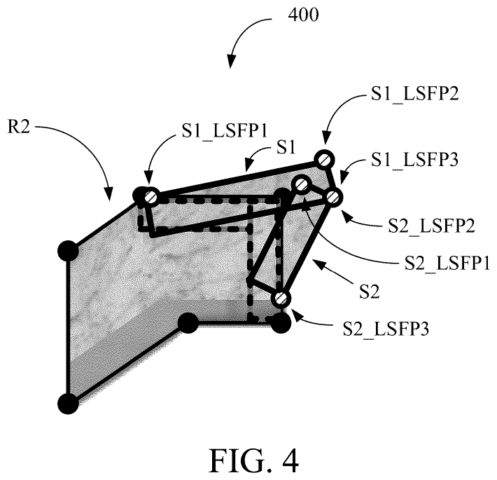

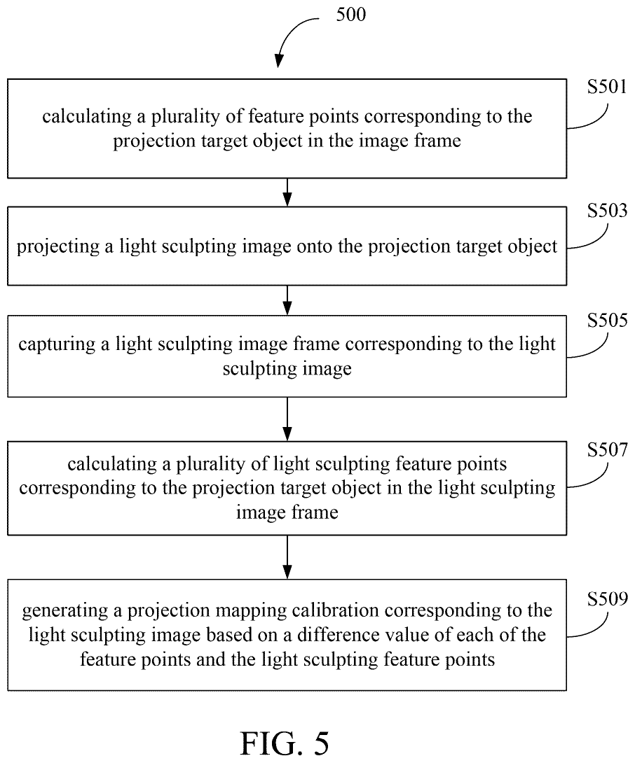

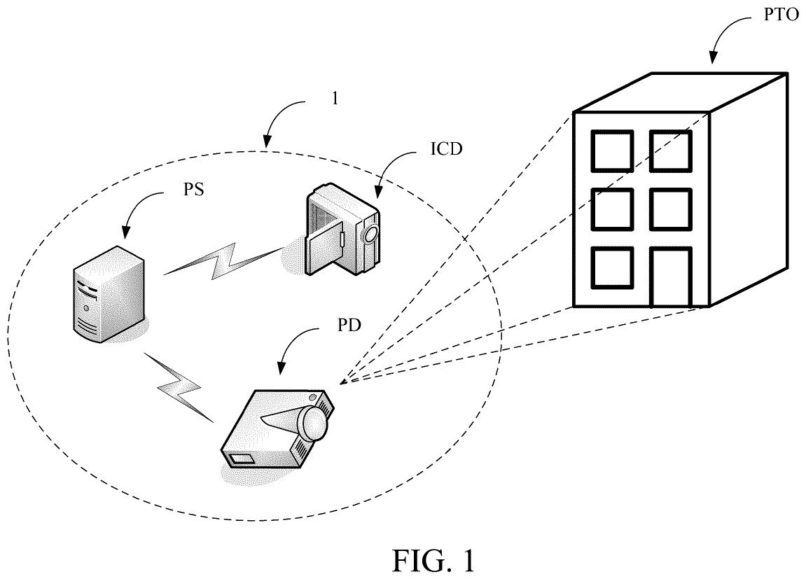

First, a first embodiment of the present disclosure is a projection mapping calibration system 1 and a schematic view of which is depicted in FIG. 1. In the present embodiment, the projection mapping calibration system 1 comprises a projection device PD, at least one image capturing device ICD, and a processor PS. The processor PS is communicatively connected to the projection device PD and the image capturing device ICD. The projection device PD is configured to project the light sculpting image onto the projection target object PTO (for example: building). The image capturing device ICD can be installed at a peripheral position of the projection target object PTO to capture image frames corresponding to the projection target object PTO.

It shall be appreciated that the image capturing device ICD can be any image capturing device with an image capture function (such as a depth camera lens). The image capturing device ICD is configured to generate a real-time image corresponding to a field of view (FOV). For example, the image capturing device ICD can be disposed in front of the projection target object PTO to capture image frames including the front side of the projection target object PTO.

In some embodiments, in order to avoid the problem of image occlusion and improve the accuracy of calibration, the projection mapping calibration system 1 can set up a plurality of auxiliary image capturing devices (i.e., at least one image capturing device ICD) at multiple angular positions of the projection target object PTO to perform calibration operations.

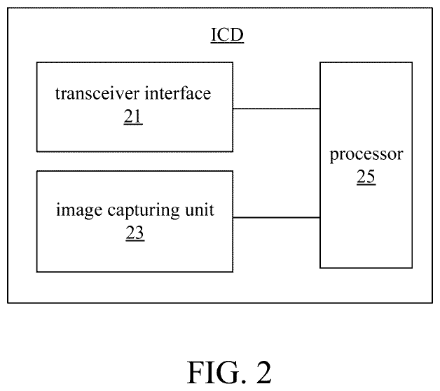

In the present embodiment, the schematic view of the image capturing device ICD is depicted in FIG. 2. The image capturing device ICD comprises a transceiver interface 21, an image capturing unit 23, and a processor 25. The processor 25 is electrically connected to the transceiver interface 21 and the image capturing unit 23, and the transceiver interface 21 is communicatively connected to the processor PS.

It shall be appreciated that the projection device PD can be any device with light sculpting image projection function. The transceiver interface 21 is an interface capable of receiving and transmitting data or other interfaces capable of receiving and transmitting data and known to those of ordinary skill in the art. The transceiver interface can receive data from sources such as external apparatuses, external web pages, external applications, and so on. The processor PS and the processor 25 may be any of various processors, Central Processing Units (CPUs), microprocessors, digital signal processors or other computing apparatuses known to those of ordinary skill in the art.

It shall be appreciated that the present disclosure does not limit the number of image capturing devices included in the projection mapping calibration system 1. The projection mapping calibration system 1 can perform calibration operations through the coordinated operation of two or more image capturing devices with mutual positioning capabilities (For example: obtaining its own position and the positions of other image capturing devices through computer vision analysis). In addition, a plurality of image capturing devices can be disposed at different positions of the projection mapping calibration system 1 (For example: the left and right sides of the projection device PD) and generate corresponding image frames with different image capturing viewing angles.

In some embodiments, in order to save device costs, the processor PS can be disposed in other devices or combined with a device having computing capabilities (For example: using the processor in the image capturing device ICD). In some implementations, the projection mapping calibration system 1 can also be directly implemented by a projection device PD having an image capturing device and a processor (For example: the image capturing device ICD and the processor PS are integrated on the projection device PD).

To facilitate understanding, the following description will be based on the projection mapping calibration system 1 including one image capturing device (i.e., the image capturing device ICD). A person with ordinary knowledge in the art should be able to understand other implementations corresponding to the number of other image capturing devices based on the contents of the present disclosure, so no details are given here.

First, in the present embodiment, the image capturing device ICD captures an image frame corresponding to the projection target object PTO. The image frame includes part or all of the projection target object PTO (for example: the area to be projected using light sculpting projection). In some embodiments, the projection mapping calibration system 1 can capture the image frames corresponding to the different areas of the projection target object PTO through multiple image capturing devices ICD.

Next, in the present embodiment, the processor PS calculates a plurality of feature points corresponding to the projection target object PTO in the image frame, for example, through edge detection or feature detection operations. In some embodiments, the feature points comprise a plurality of edge points corresponding to the projection target object PTO, and the edge points are intersection points (i.e., corner points) of two edges.

In some embodiments, the processor PS can pre-store a three-dimensional model of the projection target object PTO, and calculate the feature points corresponding to the projection target object PTO through the three-dimensional model and edge operations.

Next, in the present embodiment, the projection device PD projects a light sculpting image onto the projection target object PTO. For example, the projection device PD can receive a light sculpting image and a start-up control signal from the processor PS, and the projection device PD starts the light sculpting projection operation based on the start-up control signal.

In some embodiments, the processor PS can generate a light sculpting image through software calculation in advance based on the content to be projected and the three-dimensional model of the projection target object PTO, for example: through software such as madmapper, resolume-arena, etc.

Next, in the present embodiment, the image capturing device ICD captures a light sculpting image frame corresponding to the light sculpting image. The light sculpting image frame includes an image of the light sculpting image projected onto the projection target object PTO.

Next, in the present embodiment, the processor PS calculates a plurality of light sculpting feature points corresponding to the projection target object PTO in the light sculpting image frame. For example, the processor PS can detect feature points (e.g. edge points) of the image actually projected onto the projection target object PTO through edge detection or feature detection operations.

Finally, in this embodiment, the processor PS generates a projection mapping calibration corresponding to the light sculpting image based on a difference value of each of the feature points and the light sculpting feature points.

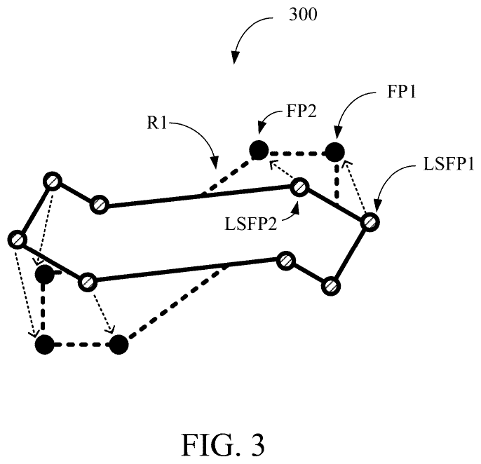

For ease of understanding, please refer to FIG. 3. FIG. 3 illustrates a schematic diagram 300 of the feature points and the light sculpting feature points. In the present example, the schematic diagram 300 illustrates the feature points FP1 and FP2 located in the region R1 (the region represented by the dotted line) of the projection target object PTO. In addition, the schematic diagram 300 illustrates the light sculpting feature points LSFP1 and LSFP2 (corresponding to the feature points FP1 and FP2 respectively) generated when the light sculpting image is actually projected on the projection target object PTO.

In the present example, the processor PS calculates the difference value of the feature point FP1 and the light sculpting feature point LSFP1 (For example: difference values of distance, depth, direction, etc.), and calculates the difference value of the feature point FP2 and the light sculpting feature point LSFP2 to generate a projection mapping calibration corresponding to the light sculpting image.

In some embodiments, the processor PS can calculate the calibration matrix corresponding to the light sculpting image through the difference values of the feature points at the same position (for example, the feature point FP1 and the light sculpting feature point LSFP1). Specifically, the processor PS generates at least one calibration matrix based on the difference value of each of the feature points and the light sculpting feature points. Then, the processor PS generates the projection mapping calibration based on the at least one calibration matrix.

It shall be appreciated that the light sculpting feature points can be corrected through the at least one calibration matrix (For example: difference values of distance, depth, direction, etc.) to adjust the projection position to the position of the feature points. Specifically, the at least one calibration matrix may include at least one of a translation transformation matrix, a Euclidean transformation matrix, a similarity transformation matrix, an affine transformation matrix, and a projective transformation matrix.

In some embodiments, the projection device PD or the processor PS can calibrate and adjust the light sculpting image based on the projection mapping calibration, and project the calibrated light sculpting image to the projection target object PTO. Specifically, the projection device PD projects a calibrated light sculpting image onto the projection target object PTO based on the light sculpting image and the projection mapping calibration.

In some embodiments, the processor PS can be used to control the opening and closing of the projection device PD to repeatedly perform the calibration operation of generating the projection mapping calibration until the value of the projection error is lower than the preset value.

In some embodiments, since the initial projection position of the projection device PD may be poor (For example: the projection angle is too small or there is an obstruction), the projection accuracy of the corrected projection image cannot be improved. At this time, the projection mapping calibration system 1 can actively perform the moving operation of the position of the projection device PD.

Specifically, the image capturing device ICD captures the light sculpting image frame corresponding to the calibrated light sculpting image. Then, the processor PS calculates a projection accuracy of the calibrated light sculpting image based on the light sculpting image frame. Finally, in response to the projection accuracy being lower than a preset accuracy, the projection device PD is moved to a new projection position based on the projection mapping calibration, and the projection device PD performs a light sculpting image projecting operation corresponding to the projection target object PTO at the new projection position.

For example, the projection mapping calibration system 1 can calculate an adjustment displacement value based on the at least one calibration matrix through the processor PS. The processor PS generates a control signal to move the projection device PD based on the adjusted displacement value.

In some embodiments, the processor PS can send a control signal to an automatic robot arm to move the projection device PD.

For another example, the projection device PD is installed on a movable gimbal. In response to the projection accuracy of the calibrated light sculpting image being lower than a preset value, the processor PS calculates an adjustment displacement value based on the at least one calibration matrix and sends a control signal to the movable gimbal. The movable gimbal moves to a new projection position based on the adjusted displacement value.

In some embodiments, the projection target object PTO may include a surface with discontinuous depth (for example, internal and external stairs), resulting in distortion of the light sculpting image. In order to alleviate this problem, the projection mapping calibration system 1 can divide the region of the calibration into smaller segments, so that each of the segments can use its own transformation matrix (for example: affine transformation matrix).

Specifically, the processor PS segments a region in the light sculpting image into a plurality of segments. Then, the processor PS calculates a segment calibration matrix corresponding to each of the segments of the region based on the feature points and the light sculpting feature points corresponding to each of the segments to generate the at least one calibration matrix.

It shall be appreciated that since a single matrix may not be able to complete the correct projection calibration, the processor PS can calculate the calibration matrix corresponding to each segment. For example, the processor PS can find the transformation matrix to fit each pair of edge points in the 2 groups based on the calculated 4 edge points of 2 groups.

For example, the affine transformation matrix can be calculated by the following equation (1):

$$[ \begin{matrix}{x}^{′} \\ {y}^{′}\end{matrix} ] = [ \begin{matrix}a & b & c \\ d & e & f\end{matrix} ] [ \begin{matrix}x \\ y \\ 1\end{matrix} ] \qquad ( 1 )$$

For an affine transformation matrix, the processor PS can use 3 pairs of xy to find a solution for 6 elements (i.e., variables a to f).

For example, the projective transformation matrix can be calculated by the following equation (2):

$$λ [ \begin{matrix}{x}^{′} \\ {y}^{′} \\ 1\end{matrix} ] = [ \begin{matrix}a & b & c \\ d & e & f \\ g & h & i\end{matrix} ] [ \begin{matrix}x \\ y \\ 1\end{matrix} ] \qquad ( 2 )$$

For the projective transformation matrix, the processor PS can use 4 pairs of xy to find a solution of 8 elements (variable i is limited to 1).

For example, the transformation matrix can also be composed of a translation and a transformation matrix, such as the following equation (3):

$$[ \begin{matrix}{x}^{′} \\ {y}^{′}\end{matrix} ] = [ \begin{matrix}{A}_{00} & {A}_{01} \\ {A}_{10} & {A}_{11}\end{matrix} ] [ \begin{matrix}x \\ y\end{matrix} ] + [ \begin{matrix}{b}_{0} \\ {b}_{1}\end{matrix} ] \qquad ( 3 )$$

$${x}^{′} = {A}_{00} x + {A}_{01} y + {b}_{0}$$

$${y}^{′} = {A}_{10} x + {A}_{11} y + {b}_{1}$$

In some embodiments, the light sculpting image projected on the projection target object PTO is generated by adjusting the projection image based on a plurality of segment calibration matrices (i.e., the projected image is produced by a combination of the respective adjusted projected image segments). Specifically, the projection device PD projects a calibrated light sculpting image onto the projection target object PTO based on the light sculpting image and the projection mapping calibration, wherein the calibrated light sculpting image corresponding to the region is generated based on the plurality of segment calibration matrix.

In some embodiments, the processor PS segments the region in the light sculpting image into the plurality of segments based on a preset edge point quantity, wherein an edge point quantity corresponding to each of the plurality of segments is not greater than the preset edge point quantity.

In some embodiments, a number of the segment correction matrices corresponds to a number of the segments, and the at least one calibration matrix includes the segment correction matrices.

In some embodiments, the preset edge point quantity is lower than a highest edge point quantity in the region of the projection target object PTO. For example, when the highest number of edge points in the region is 6 points, the processor PS segments the region into segments with less than 3 edge points (that is, each segment is composed of fewer edge points).

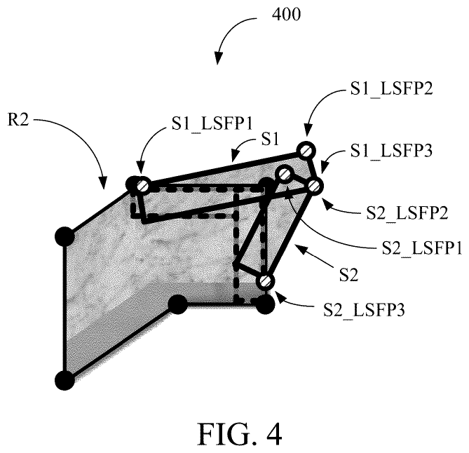

For ease of understanding, please refer to FIG. 4. FIG. 4 illustrates a schematic diagram 400 of the feature points and the light sculpting feature points. In the present example, the schematic diagram 400 illustrates a region R2 (including 6 edge points) located in the projection target object PTO, and the processor PS segments a plurality of segments from the region R2.

Taking the region R2 cut out of segments S1 and S2 as an example, segment S1 includes three edge points S1_LSFP1, S1_LSFP2, and S1_LSFP3, and segment S2 includes three edge points S2_LSFP1, S2_LSFP2, and S2_LSFP3. In the present example, the processor PS calculates the difference values between the edge points S1_LSFP1, S1_LSFP2 and S1_LSFP3 in the segment S1 and the original feature points to generate a segment calibration matrix corresponding to the segment S1. In addition, in the present example, the processor PS calculates the difference values between the edge points S2_LSFP1, S2_LSFP2, and S2_LSFP3 in the segment S2 and the original feature points to generate a segment calibration matrix corresponding to the segment S2.

In some embodiments, the processor PS can reduce the number of plural segments to be cut out by calculating the regions involving merging that require the least adjustment.

In some embodiments, the pre-generated light sculpting image can directly record the corresponding relationship (e.g., the position relationship) of each edge point to accelerate the comparison calculation time of the processor. Specifically, the light sculpting image further comprises a corresponding relationship corresponding to the edge points, and the processor PS generates the projection mapping calibration corresponding to the light sculpting image based on the corresponding relationship and the difference values.

In some embodiments, the processor PS can transmit a first control signal to cause the projection device PD to project a light sculpting image onto the projection target object PTO. Then, the processor PS can transmit a second control signal to cause the image capturing device ICD to capture a light sculpting image frame corresponding to the light sculpting image. Repeat the aforementioned switch operation and perform the calibration operation repeatedly until the projection error is less than the preset value.

According to the above descriptions, the projection mapping calibration system 1 provided by the present disclosure sets an image capturing device to capture image frame and the light sculpting image frame corresponding to the projection target object, and generates a projection mapping calibration corresponding to the light sculpting image based on the difference values between the feature points in the image frame and the light sculpting feature points in the light sculpting image frame. The projection mapping calibration system 1 provided in the present disclosure can automatically perform calibration operations through computer vision technology, and efficiently generates the projection mapping calibration without human intervention. Therefore, the projection mapping calibration system 1 provided by the present disclosure can quickly generate projection mapping calibration, improve the accuracy of the projection operation performed by the projection device, and reduce the cost of the calibration operation.

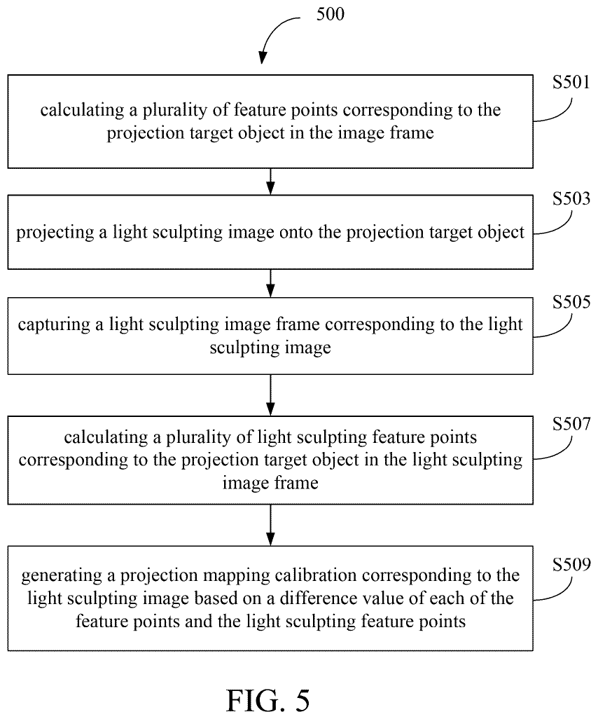

A second embodiment of the present disclosure is a projection mapping calibration method and a flowchart thereof is depicted in FIG. 5. The projection mapping calibration method 500 is adapted for an electronic system (e.g., the projection mapping calibration system 1 of the first embodiment). The electronic system comprises a projection device, an image capturing device, and a processor (e.g., the projection device PD, the image capturing device ICD, and the processor PS of the first embodiment). The image capturing device is configured to capture an image frame corresponding to a projection target object. The projection mapping calibration method 500 generates a projection mapping calibration through the steps S501 to S509.

In the step S501, the electronic system calculates a plurality of feature points corresponding to the projection target object in the image frame. Next, in the step S503, the electronic system projects a light sculpting image onto the projection target object.

Next, in the step S505, the electronic system captures a light sculpting image frame corresponding to the light sculpting image. Next, in the step S507, the electronic system calculates a plurality of light sculpting feature points corresponding to the projection target object in the light sculpting image frame.

Finally, in the step S509, the electronic system generates a projection mapping calibration corresponding to the light sculpting image based on a difference value of each of the feature points and the light sculpting feature points.

In some embodiments, wherein the feature points comprise a plurality of edge points corresponding to the projection target object.

In some embodiments, wherein the light sculpting image further comprises a corresponding relationship corresponding to the edge points, and the step of generating the projection mapping calibration comprises the following steps: generating the projection mapping calibration corresponding to the light sculpting image based on the corresponding relationship and the difference values.

In some embodiments, the projection mapping calibration method 500 further comprises the following steps: projecting a calibrated light sculpting image onto the projection target object based on the light sculpting image and the projection mapping calibration.

In some embodiments, the projection mapping calibration method 500 further comprises the following steps: capturing the light sculpting image frame corresponding to the calibrated light sculpting image; calculating a projection accuracy of the calibrated light sculpting image based on the light sculpting image frame; and in response to the projection accuracy being lower than a preset accuracy, moving the projection device to a new projection position based on the projection mapping calibration, wherein the projection device performs a light sculpting image projecting operation corresponding to the projection target object at the new projection position.

In some embodiments, the step of generating the projection mapping calibration comprises the following steps: generating at least one calibration matrix based on the difference value of each of the feature points and the light sculpting feature points; and generating the projection mapping calibration based on the at least one calibration matrix.

In some embodiments, the step of generating the at least one calibration matrix comprises the following steps: segmenting a region in the light sculpting image into a plurality of segments; and calculating a segment calibration matrix corresponding to each of the segments of the region based on the feature points and the light sculpting feature points corresponding to each of the segments to generate the at least one calibration matrix.

In some embodiments, the projection mapping calibration method 500 further comprises the following steps: projecting a calibrated light sculpting image onto the projection target object based on the light sculpting image and the projection mapping calibration, wherein the calibrated light sculpting image corresponding to the region is generated based on the plurality of segment calibration matrix.

In some embodiments, the step of segmenting the light sculpting image into the plurality of segments further comprises the following steps: segmenting the region in the light sculpting image into the plurality of segments based on a preset edge point quantity, wherein an edge point quantity corresponding to each of the plurality of segments is not greater than the preset edge point quantity.

In addition to the aforesaid steps, the second embodiment can also execute all the operations and steps of the projection mapping calibration system 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The projection mapping calibration method described in the second embodiment may be implemented by a computer program having a plurality of codes. The computer program may be a file that can be transmitted over the network, or may be stored into a non-transitory computer readable storage medium. After the codes of the computer program are loaded into an electronic system (e.g., the projection mapping calibration system 1), the computer program executes the projection mapping calibration method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

According to the above descriptions, the projection mapping calibration technology (at least including the system, the method, and the non-transitory computer readable storage medium) provided by the present disclosure sets an image capturing device to capture image frame and the light sculpting image frame corresponding to the projection target object, and generates a projection mapping calibration corresponding to the light sculpting image based on the difference values between the feature points in the image frame and the light sculpting feature points in the light sculpting image frame. The projection mapping calibration technology provided in the present disclosure can automatically perform calibration operations through computer vision technology, and efficiently generates the projection mapping calibration without human intervention. Therefore, the projection mapping calibration technology provided by the present disclosure can quickly generate projection mapping calibration, improve the accuracy of the projection operation performed by the projection device, and reduce the cost of the calibration operation.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A projection mapping calibration system, comprising:
a projection device;
an image capturing device, being configured to capture an image frame corresponding to a projection target object; and
a processor, being communicatively connected to the projection device and the image capturing device;
wherein the projection mapping calibration system is configured to perform operations comprising:
calculating, by the processor, a plurality of feature points corresponding to the projection target object in the image frame;
projecting, by the projection device, a light sculpting image onto the projection target object;
capturing, by the image capturing device, a light sculpting image frame corresponding to the light sculpting image;
calculating, by the processor, a plurality of light sculpting feature points corresponding to the projection target object in the light sculpting image frame; and
generating, by the processor, a projection mapping calibration corresponding to the light sculpting image based on a difference value of each of the feature points and the light sculpting feature points.

2. The projection mapping calibration system of claim 1, wherein the feature points comprise a plurality of edge points corresponding to the projection target object.

3. The projection mapping calibration system of claim 2, wherein the light sculpting image further comprises a corresponding relationship corresponding to the edge points, and the operation of generating the projection mapping calibration comprises the following operations:
generating, by the processor, the projection mapping calibration corresponding to the light sculpting image based on the corresponding relationship and the difference values.

4. The projection mapping calibration system of claim 1, wherein the projection mapping calibration system further performs the following operations:
projecting, by the projection device, a calibrated light sculpting image onto the projection target object based on the light sculpting image and the projection mapping calibration.

5. The projection mapping calibration system of claim 4, wherein the projection mapping calibration system further performs the following operations:
capturing, by the image capturing device, the light sculpting image frame corresponding to the calibrated light sculpting image;
calculating, by the processor, a projection accuracy of the calibrated light sculpting image based on the light sculpting image frame;
in response to the projection accuracy being lower than a preset accuracy, moving the projection device to a new projection position based on the projection mapping calibration, wherein the projection device performs a light sculpting image projecting operation corresponding to the projection target object at the new projection position.

6. The projection mapping calibration system of claim 1, wherein the operation of generating the projection mapping calibration comprises the following operations:
generating, by the processor, at least one calibration matrix based on the difference value of each of the feature points and the light sculpting feature points; and
generating, by the processor, the projection mapping calibration based on the at least one calibration matrix.

7. The projection mapping calibration system of claim 6, wherein the operation of generating the at least one calibration matrix comprises the following operations:
segmenting, by the processor, a region in the light sculpting image into a plurality of segments; and
calculating, by the processor, a segment calibration matrix corresponding to each of the segments of the region based on the feature points and the light sculpting feature points corresponding to each of the segments to generate the at least one calibration matrix.

8. The projection mapping calibration system of claim 7, wherein the projection mapping calibration system further performs the following operations:
projecting, by the projection device, a calibrated light sculpting image onto the projection target object based on the light sculpting image and the projection mapping calibration, wherein the calibrated light sculpting image corresponding to the region is generated based on the plurality of segment calibration matrix.

9. The projection mapping calibration system of claim 7, wherein the operation of segmenting the light sculpting image into the plurality of segments further comprises the following operations:
segmenting, by the processor, the region in the light sculpting image into the plurality of segments based on a preset edge point quantity, wherein an edge point quantity corresponding to each of the plurality of segments is not greater than the preset edge point quantity.

10. The projection mapping calibration system of claim 9, wherein the preset edge point quantity is lower than a highest edge point quantity in the region of the projection target object.

11. A projection mapping calibration method, being adapted for use in an electronic system, wherein the electronic system comprises a projection device, an image capturing device, and a processor, the image capturing device is configured to capture an image frame corresponding to a projection target object, and the projection mapping calibration method comprises:
calculating a plurality of feature points corresponding to the projection target object in the image frame;
projecting a light sculpting image onto the projection target object;
capturing a light sculpting image frame corresponding to the light sculpting image;
calculating a plurality of light sculpting feature points corresponding to the projection target object in the light sculpting image frame; and
generating a projection mapping calibration corresponding to the light sculpting image based on a difference value of each of the feature points and the light sculpting feature points.

12. The projection mapping calibration method of claim 11, wherein the feature points comprise a plurality of edge points corresponding to the projection target object.

13. The projection mapping calibration method of claim 12, wherein the light sculpting image further comprises a corresponding relationship corresponding to the edge points, and the step of generating the projection mapping calibration comprises the following steps:
generating the projection mapping calibration corresponding to the light sculpting image based on the corresponding relationship and the difference values.

14. The projection mapping calibration method of claim 11, wherein the projection mapping calibration method further comprises the following steps:
projecting a calibrated light sculpting image onto the projection target object based on the light sculpting image and the projection mapping calibration.

15. The projection mapping calibration method of claim 14, wherein the projection mapping calibration method further comprises the following steps:
capturing the light sculpting image frame corresponding to the calibrated light sculpting image;
calculating a projection accuracy of the calibrated light sculpting image based on the light sculpting image frame; and
in response to the projection accuracy being lower than a preset accuracy, moving the projection device to a new projection position based on the projection mapping calibration, wherein the projection device performs a light sculpting image projecting operation corresponding to the projection target object at the new projection position.

16. The projection mapping calibration method of claim 11, wherein the step of generating the projection mapping calibration comprises the following steps:
generating at least one calibration matrix based on the difference value of each of the feature points and the light sculpting feature points; and
generating the projection mapping calibration based on the at least one calibration matrix.

17. The projection mapping calibration method of claim 16, wherein the step of generating the at least one calibration matrix comprises the following steps:
segmenting a region in the light sculpting image into a plurality of segments; and
calculating a segment calibration matrix corresponding to each of the segments of the region based on the feature points and the light sculpting feature points corresponding to each of the segments to generate the at least one calibration matrix.

18. The projection mapping calibration method of claim 17, wherein the projection mapping calibration method further comprises the following steps:
projecting a calibrated light sculpting image onto the projection target object based on the light sculpting image and the projection mapping calibration, wherein the calibrated light sculpting image corresponding to the region is generated based on the plurality of segment calibration matrix.

19. The projection mapping calibration method of claim 17, wherein the step of segmenting the light sculpting image into the plurality of segments further comprises the following steps:
segmenting the region in the light sculpting image into the plurality of segments based on a preset edge point quantity, wherein an edge point quantity corresponding to each of the plurality of segments is not greater than the preset edge point quantity.

20. A non-transitory computer readable storage medium, having a computer program stored therein, wherein the computer program comprises a plurality of codes, the computer program executes a projection mapping calibration method after being loaded into an electronic system, the electronic system comprises a projection device, an image capturing device, and a processor, the image capturing device is configured to capture an image frame corresponding to a projection target object, and the projection mapping calibration method comprises:
calculating a plurality of feature points corresponding to the projection target object in the image frame;
projecting a light sculpting image onto the projection target object;
capturing a light sculpting image frame corresponding to the light sculpting image;
calculating a plurality of light sculpting feature points corresponding to the projection target object in the light sculpting image frame; and
generating a projection mapping calibration corresponding to the light sculpting image based on a difference value of each of the feature points and the light sculpting feature points.
